(19) United States
(12) Patent Application Publication
(10) Pub. No.: US 2004/0098409 A1
(43) Pub. Date: May 20, 2004

(54) Adaptable screening system and method

(76) Inventors: Kelly J. Kelleher, Columbus, OH (US); John C. Walker, Pittsburgh, PA (US); James B. Ummer, Pittsburgh, PA (US); Eugene B. Ginzburg, Pittsburgh, PA (US); Nathaniel J. See, Glenshaw, PA (US); Justin M. Bass, Pittsburgh, PA (US)

Correspondence Address: Buchanan Ingersoll, P.C., One Oxford Centre, 20th Floor, 301 Grant Street, Pittsburgh, PA, 15219, US

(21) Appl. No.: 10/295,295

(22) Filed: Nov. 15, 2002

(51) Int. Cl. G06F 17/00; G06F 7/00

(52) U.S. Cl. 707/104.1

(57) ABSTRACT

The invention consists of a system and method for administering respondent screenings, such as in the context of a patient in a doctor's office. Respondents access a web site using a portable web appliance and are presented with a series of questions. The questions are selected for each individual respondent from a large database of questions, based on certain criteria. At the conclusion of the session, one or more reports are printed out for the respondent and any other interested parties, which may have certain questions “red-flagged” to draw the attention of the respondent and/or administrator.

### BACKGROUND OF THE INVENTION

The major cause of morbidity and mortality among children and adolescents is related to safety and behavioral issues. Primary care clinicians are ideally suited to identify and intervene these conditions if they can identify families and children in need of assistance. However, studies of current practice suggest that primary care clinicians are woefully ill equipped, both in the assessment of these issues and in their documentation.

Already an issue of poor quality of care for patients, the lack of attention to behavioral, developmental and safety screening for children may become a liability issue in the future for primary care clinicians, because of the growing number of accountability measures requiring their assessment and documentation. Compounding this are the increasing demands with decreasing resources available to both clinicians and their staff. The intensive accountability of management health care demands a better system for tracking patient's safety, developmental, and psychosocial needs, as well as documenting outcomes. To assist in this, paper based screening tools and parent information packets have been developed. However, the extensive investment of both time and money in the administration and processing of such forms precludes wide spread adoption of these instruments. In the face of competing demands, clinicians simply do not have the time required to effectively implement programs of comprehensive safety developmental, and behavioral screening, as they now exist.

It is a common experience to be presented, prior to a scheduled appointment with clinician, an information survey to be filled out in the waiting room. Such information surveys usually collect information such as the patient's demographic information, physical information, medical background information, etc. One problem with such surveys is that they rarely include questions dealing with safety, developmental and psychosocial factors. Further, such surveys are typically of the pencil and paper variety and are therefore time consuming for the clinician to interpret during the brief time spent with each patient. As a result, even if the surveys include questions regarding important issues, it is unlikely that the clinicians will take the time to interpret the results and address these issues, especially in the context of a sick visit.

Therefore, it would be desirable to provide a method whereby information regarding safety, developmental and psychosocial issues can be easily collected from the patient, interpreted, and presented to the clinician in an organized manner that makes it easy and time-effective to address these types of issues in the context of a typical sick or well office visit.

### SUMMARY OF THE INVENTION

Disclosed herein is a computerized screening tool that offers clinicians, and in particular pediatricians, a more efficient and effective way to screen for and treat patient safety, developmental and psychosocial issues in a primary care context. The invention is a first step in an attempt to bridge the gap between the medical and the psycho sciences through the use of interactive technologies, computer science and information science techniques. A properly implemented embodiment of this invention can significantly reduce the lag time in the identification of safety, developmental and psychosocial problems, and can improve office efficiency and documentation. Unlike other existing patient screening products, this invention easily integrates into the clinician's practice and workflow.

The system consists primarily of a web-enabled tablet style personal computer that is presented to the patient upon check in at the clinician's office. The web-enabled personal computer automatically accesses a web site which presents the patient with a series of safety, developmental and psychosocial related questions. The questions are selected specifically for the patient responding, and the patient is identified with a unique identification number that identifies not only the patient but the primary care office. The questions presented to the patients are drawn from a large database of questions that are ranked in an order of importance for each specific patient according to several factors. These factors include (but are not limited to) the age of the patient, the patient's medical background, the time of year and responses to questions collected during previous office visits.

The system analyzes the collected information and red flags certain responses for the doctor's attention. Additionally, questions presented may be altered in real time depending upon responses received from the patient's previous questions. Therefore, a particular response to a question may elicit the introduction of several other questions that would not have been asked had a different response been received from the initial question. The number of questions that each patient is requested to respond to is limited and, therefore, not all questions that are initially selected may be asked, depending on if the responses to some questions require that an additional question or questions be asked. The doctor's office is then provided with a report of the patient's responses with those questions that raise red flags, marked in a special way to draw the clinician's attention thereto. The report is printed out in the clinician's office prior to the start of the interaction between the clinician and the patient. Therefore, this makes it extremely easy for the doctor to notice those issues that are red flagged and to discuss them with the patient during the office visit. Furthermore, a report is prepared for the patient as a take home item that may include information blurbs or courses of action for follow-up information gathering for those issues that have been red flagged.

In other embodiments of the invention, the system and method can be used in a more general, non-medical context, where a respondent is asked a series of questions and provides responses thereto for a variety of applications.

### BRIEF DESCRIPTION OF THE DRAWINGS

FIG. 1 is a system level diagram of the present invention.

FIG. 2 is a flow chart showing the flow of the patient through the doctor's office.

FIG. 3 is a flow chart showing the interaction between the client and the server systems.

FIG. 4 is a flow chart showing the administration of the screening questions.

FIG. 5 is a flow chart showing the creation of question sets.

FIGS. 6a-6j show captured screen displays of the exemplary embodiment of the invention.

### DETAILED DESCRIPTION OF THE INVENTION

The invention is explained herein in the context of an implementation for a pediatrician's office. However, the invention is not meant to be limited by the exemplary implementation. The system is equally effective when used in the offices of varying types of clinicians. It is contemplated, for example, that the system may be used in settings for women and in sports medicine practices. Further, the questions asked need not be related to safety, developmental and psychosocial problems to come within the scope of this invention. It is contemplated that the invention could also be used during a sick visit to the clinician's office to elicit information from a patient regarding various symptoms and other information which may be useful to the clinician in the diagnosis of the patient's condition, or in a non-medical setting.

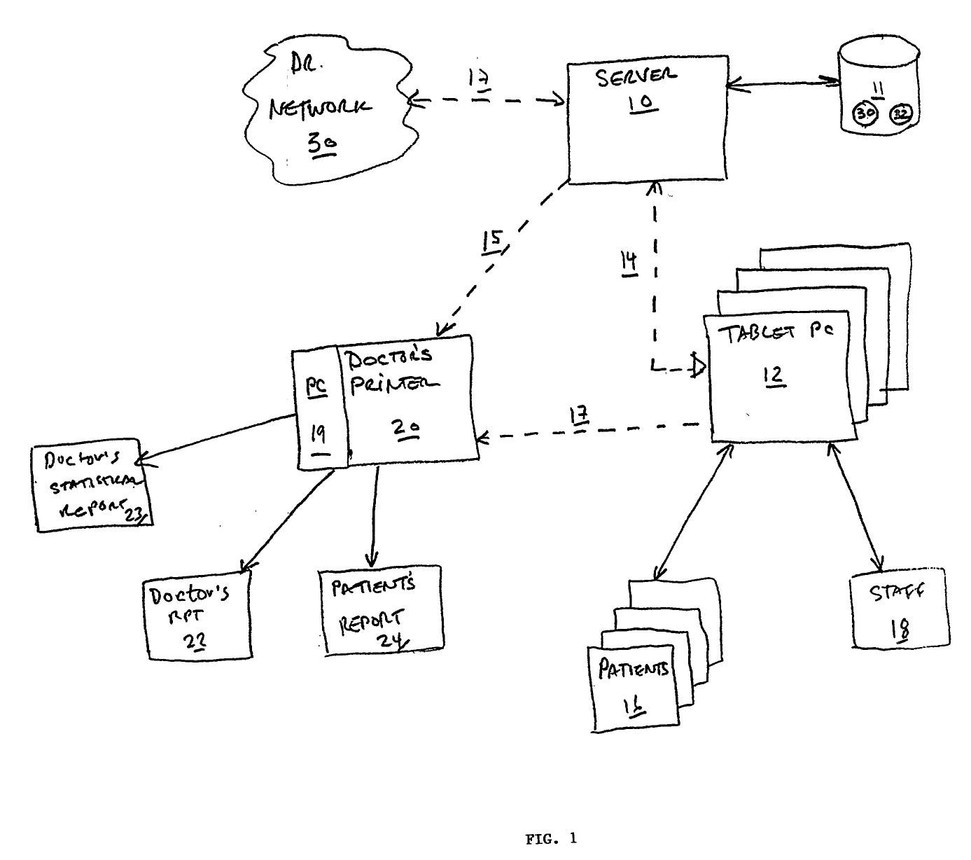

With reference to FIG. 1, server 10 runs a world wide web page server from a central location. Storage media 11, which is accessible by server 10, contains a database of questions 30 and a patient database 32. Patients 16 visiting a doctor's office will be presented with a series of questions using a tablet-style personal computer 12, or a “web tablet.” Alternatively, a standard desktop or laptop personal computer, a web-enabled cell phone or palm device, or any other web-enabled appliance could be used. Preferably, web tablet 12 has a touch sensitive screen in lieu of a keyboard, and is wirelessly connected to an access point in the doctor's office which has access to the internet or to a local-area network which is supporting the service. Patients 16 can therefore respond to the series of questions by taking web tablet 12 to a seat in the waiting room and touching areas displayed on the screen of web tablet 12.

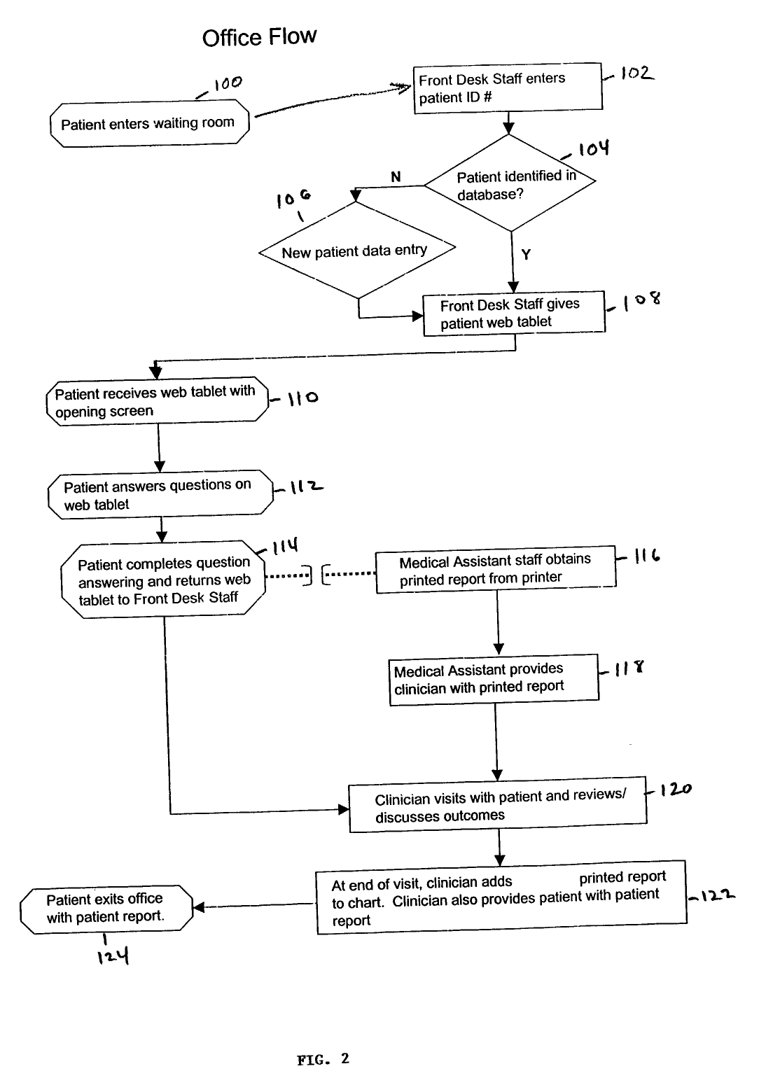

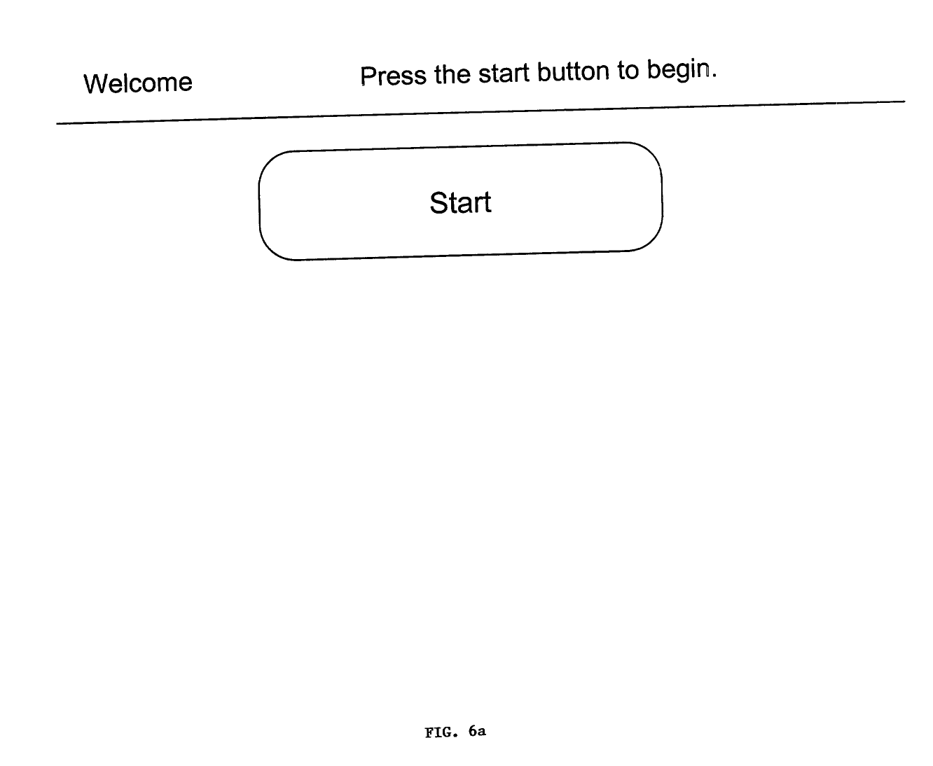

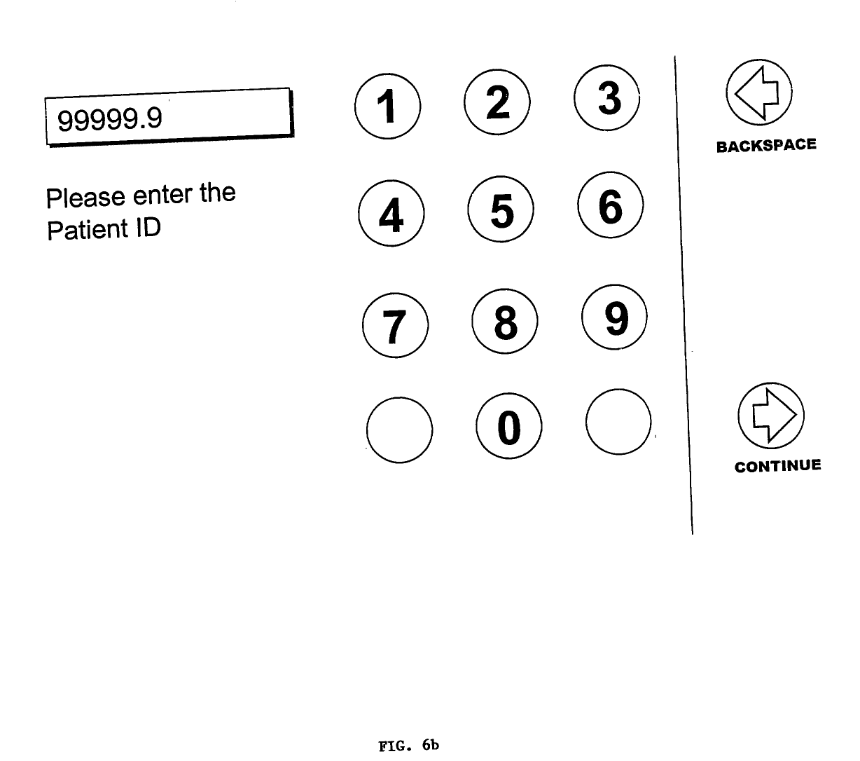

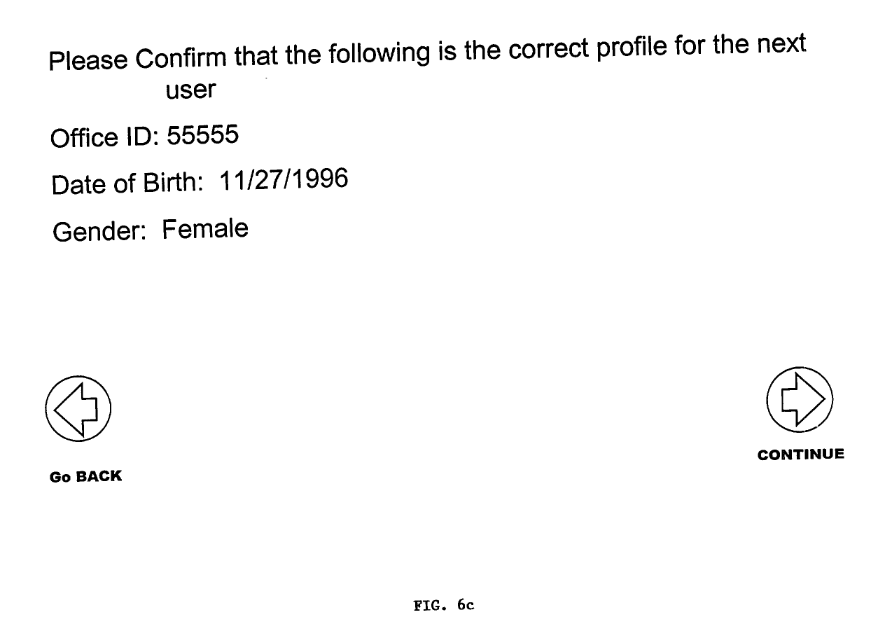

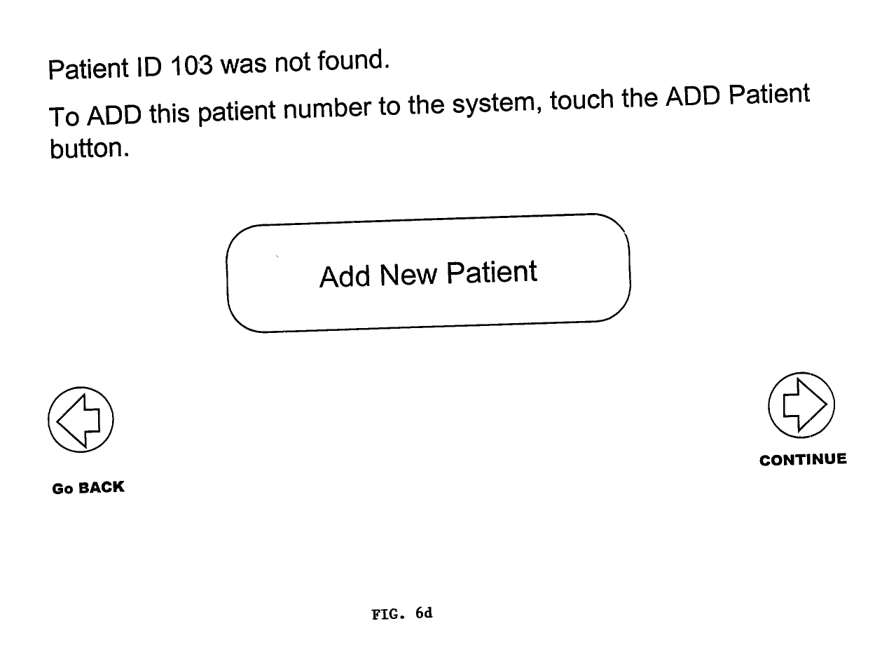

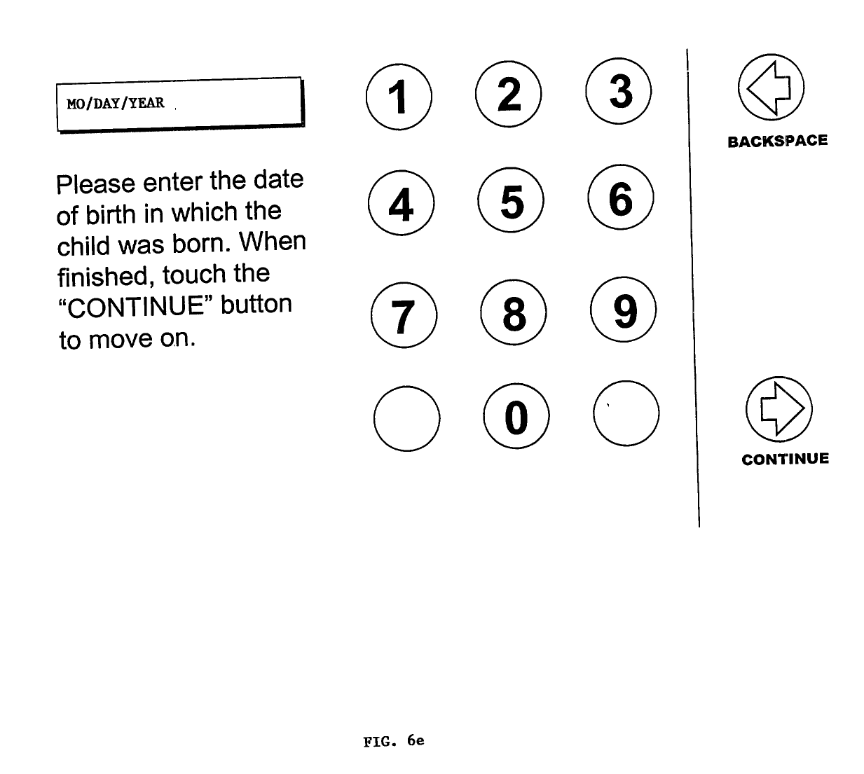

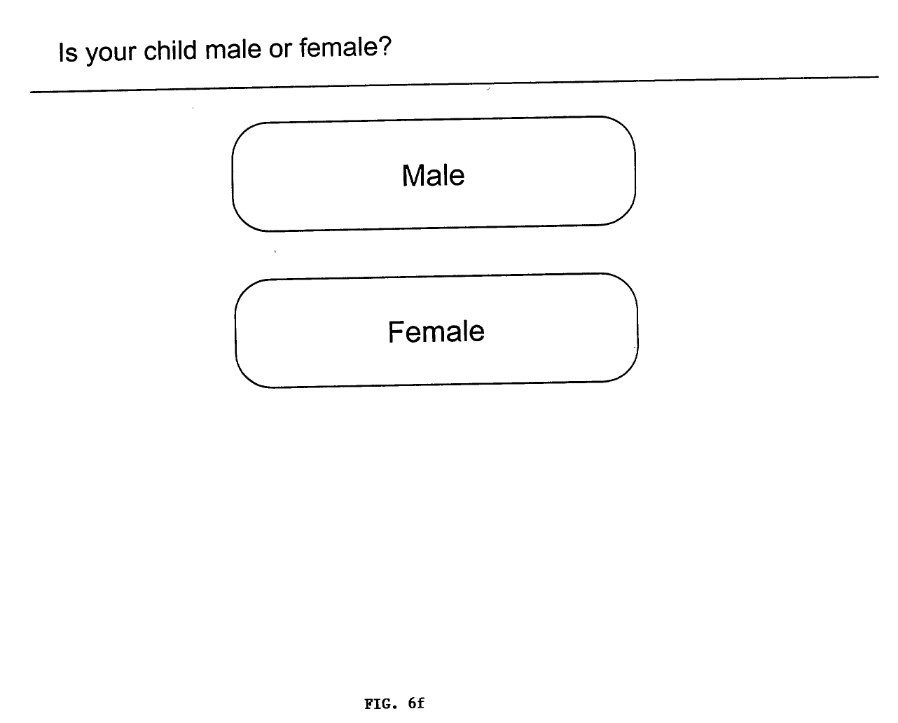

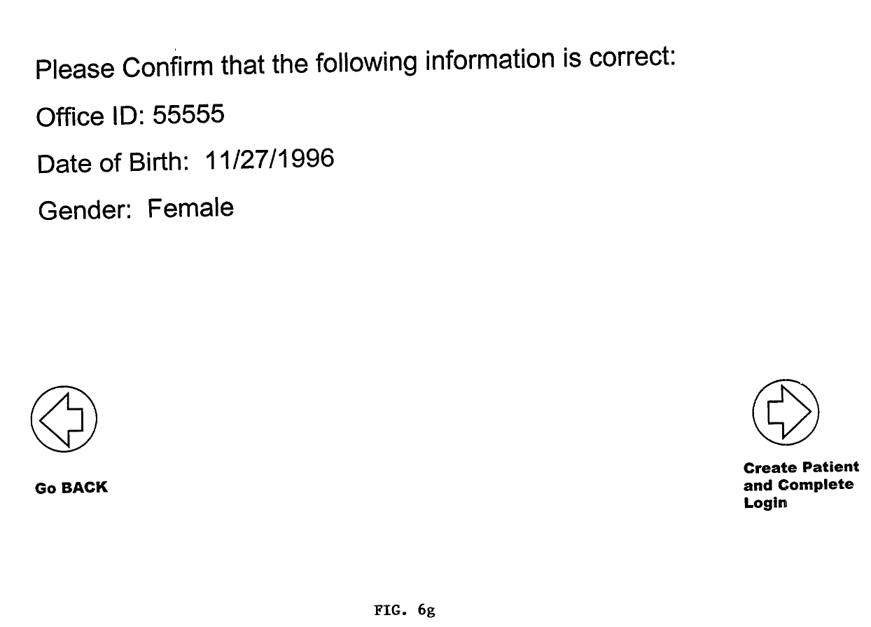

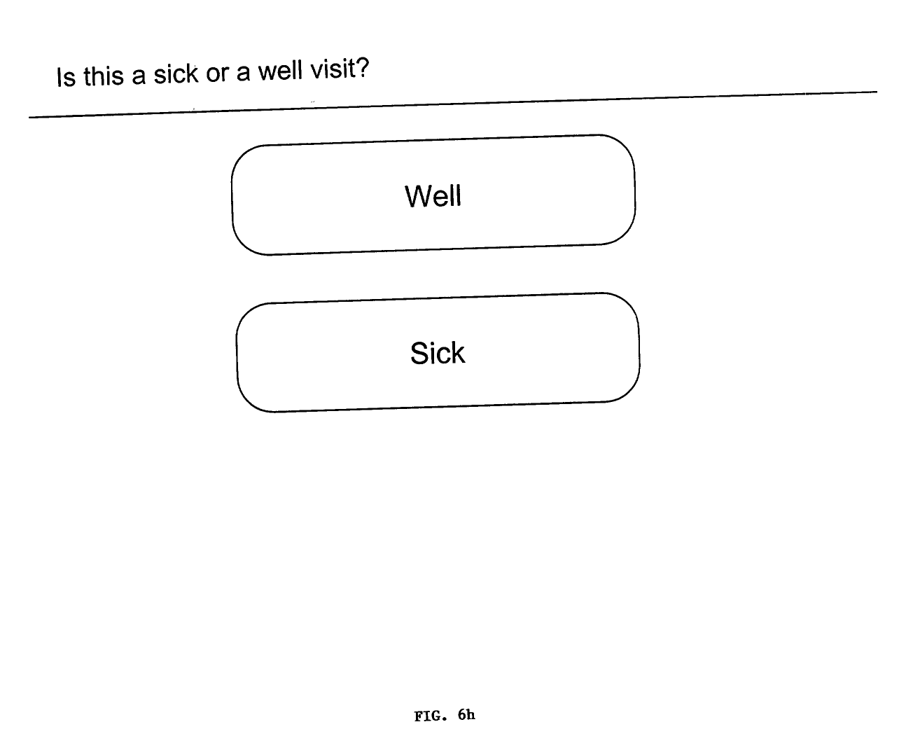

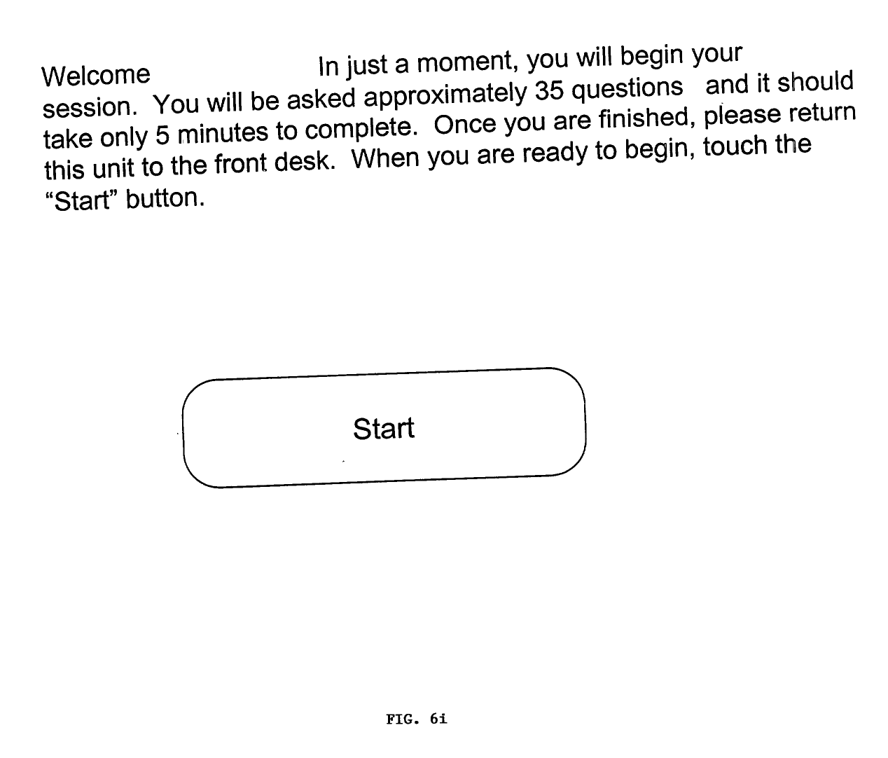

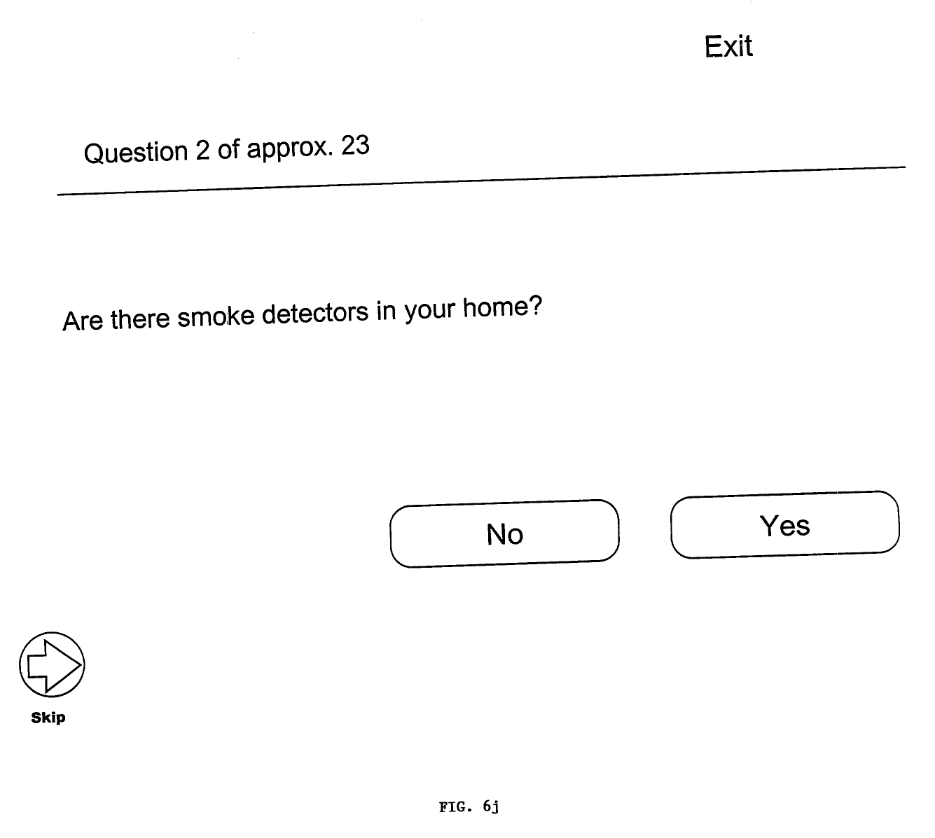

The patient enters the doctor's office at box 100 in FIG. 2 and checks in with the staff 18. Prior to handing web tablet 12 to the patient 16, web tablet 12 would be initialized by staff 18 of the doctor's office. The initialization procedure is started by pressing a “START” button, as shown in FIG. 6a. The initialization procedure would consist primarily of the entry of a patient identification number capable of uniquely identifying the patient in patient database 32, at box 102 in FIG. 2 and as shown in FIG. 6b. The number may also serve to uniquely identify the doctor's office. At box 104 a check is made to determine if the patient identifier is already in the patient database 32. If the patient's identification number is already in patient database 32, a screen asking for verification of the patient's profile, as shown in FIG. 6c, is displayed. If the patient's identification number is not in patient database 32, and new patient entry is made at box 106. The new patient entry is shown in FIGS. 6d-6g, wherein staff 18 is prompted to enter various information about the patient 16, such as birth date (FIG. 6e) and gender (FIG. 6f). Lastly, staff 18 is asked to indicate, as in FIG. 6h, if the patient's visit to the office is a “sick” visit or a “well” visit (i.e., annual physical, etc.).

After initialization of web tablet 12, the staff will hand the web tablet 12 to patient 16 at box 110. The patient then indicates that he is ready to start by pressing a start button, as shown in FIG. 6i. Web tablet 12 will automatically connect, via an internet connection 14, to the world wide web page server on server 11, which will serve the series of questions to patient 16 and collect the patient's responses utilizing a customized web page at box 112. The patient is presented with a series of questions selected from database 11, which are customized for the individual patient 16, based on certain criteria. An example of such a question is shown in FIG. 6j. Preferably, the questions will be legible and understandable by a large percentage of patients 16 and will be of the “forced choice” or “multiple choice” variety, such that they can be responded to by pressing a button graphic displayed in the screen of web tablet 12. The number of questions that patient 16 is asked to respond to will be limited either by an absolute number or by an elapsed time feature. In the preferred embodiment, the number of questions is limited to about 35, or about 5 minutes elapsed time, after which a patient will not be asked any further questions. When patient 16 has completed the questionnaire, web tablet 12 is returned to staff 18 for use by another patient in box 114.

The questions presented to patient 16 are selected from a large database of questions 32. The questions, in the exemplary implementation for a pediatrician's office, are designed to elicit information from patient 16 (or, in the exemplary implementation, the parent or guardian of patient 16), regarding various safety, developmental and psychosocial issues. The responses to the questions can be analyzed to discover potential problems in areas such as safety, environment and development.

All of the individual screening questions and associated data are stored in a number of question databases 32 referred to as the question matrix. For each question in the question matrix, a number of items are stored including:

Question text—The actual text that will appear on the screen when the screening question is presented to patient 16. This could be in any number of languages.

Index number—A unique number for each question.

Question Status—Questions can be in a number of states of completeness, allowing questions in the question matrix to be under development (non-live).

Descriptive Criteria Items—Explained below.

Criteria Relevancy—Explained below.

Responses to be used in reports—When reports are generated, these are the text strings that appear in the reports.

Creation and modification dates for the question—The date the question was first entered and when it was last modified.

Additional question information.

There are two types of questions that can be administered by the invention—stand alone questions and series questions. Stand alone questions are questions that are asked and responded to without being effected by preceding questions and without effecting subsequent questions. Series questions are two or more questions that are asked, responded to and scored under rules specific to that series, regardless of the number of questions in the series. The entire series is normally selected, scored and reported as if it were a single question.

There are a number of descriptive criteria items that are recorded for each question in the question matrix. These criteria are evaluated against the respondent's state to determine the most appropriate questions for a given respondent during a specific session. In the exemplary implementation of the invention, which is a pediatrics application, the questions module contains the following descriptive criteria items for each question.

General Category: Major category classification used for question distribution purposes.

Specific Category: A minor category classification used for question distribution purposes.

Gender: The gender for which the question is targeted.

Age Range: The age range for which the question is targeted.

Season: The time of year during which the question is targeted.

Re-ask Red: The period of time in months after which the question should be asked again if the patient's previous response caused the question to be red-flagged.

Re-ask White: The period of time in months after which the question should be asked if the patient's previous response did not cause the question to be red-flagged.

Visit Type: The type of visit, sick or well, for which the question may be asked.

Modules for applications other than the exemplary implementation of a pediatrics module may contain different descriptive criteria items.

The entry of the questions and their relevancy criteria is controlled by a content controller application. This is a web based application whose primary function is to allow multiple content providers (i.e., doctors, clinicians, researchers, staff etc.) to remotely collaborate on creating and updating the question matrix. Additional content controller functionality includes sample testing, system configuration and reporting of cumulative screening results. It also allows perspective clients to view the screening questions for various modules.

On a special web site, clinicians are able to enter question content into the system using the content controller application. This web site is designed for the clinician to enter a question and define each entered question with a set of criteria and meta information. The following is an exemplary list and a brief description of question criteria for the pediatric embodiment of the invention. Question criteria for other embodiments of the invention may be different, and the invention is not meant to be limited by these specific criteria.

Question Verbiage: This box is used to enter the question to be provided to the patient as it will be displayed on the web tablet 12.

Pointer to a Series: A check box is provided where the clinician can indicate if this question is a leader question to a series of additional questions. If unchecked, the question is considered a stand alone question and will not lead to the asking of additional questions in a series. A facility is also provided to add and edit questions in the series.

Well/Sick Question: This selection determines whether the question is to be provided to patients who are visiting the doctor's office for a well or sick visit.

General Category: Indicates under which general category the question falls.

A drop-down box may be provided containing all of the possible general categories for a particular module. General categories may change for different modules of question.

Specific Category: Indicates under which specific category the question falls.

A drop-down box may be provided containing all of the possible specific categories for a particular module. Specific categories may change for different modules of question.

Gender: Indicates the gender of the patient that is to receive the question.

Age Range: Indicates the minimum and maximum patient age ranges for this question to be asked. Ages can also be specified in “only after a certain age” form.

Re-ask Previous White: Indicates when this question should be re-asked if the patient's previous answer response is a white-flagged item.

Re-ask Previous Red: Indicates when this question should be re-asked if the patient's previous response is a red-flagged item.

Time of the Year: Specifies the month of the year when this question should be asked.

Key Word: Allows the entry of a keyword for additional information that can be obtained on a web site provided specifically for the patient. The keyword entered here by the clinician is provided to the patient via the patient report 24. The patient then visits the website and enters the keyword provided. The patient is then presented with another website containing information about the specific issue to be addressed.

Web Link: Allows the entry of the URL of the web site to be accessed for additional information by the patient. This URL is printed on the patient report 24.

Web-Link Name: Allows the entry of a name corresponding to the web link that is to appear on the patient report 24.

Phone Number: Allows the entry of a phone number that the patient can call for additional information. The phone number is provided to the patient via patient report 24.

Phone Number Name: Allows the entry of a name corresponding to the phone number that is to appear on the patient report 24.

Red-Screen Response: Allows the clinician to enter the paragraph of additional information for this question that will appear on the patient report 24 in the event that the patient's response to this question causes the question to be red-flagged.

Red-Screen Summary: Allows the clinician to enter text that will be displayed on the doctor report 22.

White-Screen Summary: Allows the clinician to enter text that will be displayed on the doctor report 22 if the patient's response to this question causes the question to be white-flagged.

Red-Flagged Question Rules: Indicates the treatment of summary and responses on patient reports 24 and doctor reports 22. Normally, this information for red-flagged questions is printed on both the patient report 24 and the doctor's report 22.

Question Resource: Indicates any resources necessary for this question's content. Resources are used by other clinicians in the system to verify the quality of a question's content, criteria and meta information.

Question Status: Indicates the completeness of information and approval status of a question.

Note that many of the criteria will also have a relevancy attribute. The relevancy attribute is a numerical indicator of the question's required adherence to a particular criteria, with low numbers indicating a low adherency and high number indicating high adherency. For example, if the gender criteria for a particular question is indicated as being “female”, but has a low adherency number, the question may be asked for a male. However, if the adherency number is high, the question will most likely only be asked of female patients.

A set of questions to be presented to each individual patient 16 is formulated based on a scoring of each question in question database 30 based on the criteria and related relevancy factors. As patient 16 responds to questions, server 11 may determine that a deviation from the original list of questions is necessary. For example, a certain response to a series leader question will cause the asking of additional questions in the series. As an example, if the patient responds yes to a question regarding bicycle riding, server 11 my ask additional questions regarding bicycle riding such as “Does the child wear a helmet while riding the bike?”, etc. Therefore, not all questions originally selected to be asked to patient 16 may be completed in the session, as the total number of questions asked, as previously stated, may be limited by an absolute number or by elapsed time.

Once a patient 16 has completed the sequence of questions using web tablet 12, a report 22 is prepared for the doctor and sent via connection 15 to a printer in the clinician's office for the rendering of a hard copy of report 22, which is preferably delivered to the clinician prior to the period of patient interaction, in boxes 116 and 118 of FIG. 2. The report 22 will have certain issues or questions “red flagged” which indicates that the patient's response to that question may indicate that an issue is present, which will give the clinician a “heads up” as to some issues to discuss with patient 16 during the period of time when the clinician is interacting with patient 16, at box 120. Preferably, the hard copy of doctor's report 22 is available for the doctor to carry in to the examination room and for filing in the patient's medical record, indicating issues that the doctor has discussed with patient 16. The red-flagged questions in the doctor's report are those for which the patient's response has raised issues regarding potential problems in the areas of safety, environment and the development of patient 16.

Also printed out from doctor's printer 20 is a report for the patient 24 at box 122. The patient's report 24 is a take-home item that contains information that may be useful to patient 16 regarding the issues raised by the red flagged questions. For instance, in the example where the patient is asked if the child rides a bicycle, the patient's report 24 may include information blurbs containing statistics for accident rates for children riding bicycles with and without helmets, or it may include information regarding upcoming safety seminars for bicycle riders, etc.

The responses given by patients 16 on web tablet 12 are stored in patient's database 32 on server 10 such that the responses to these questions may be used in the future as criteria for the selection of questions for future visits of patients 16 to the clinician's office. For example, a particular question regarding an unresolved issue may be re-asked during the patient's next visit.

The responses to the questions will be held in confidence and a particular patient's responses to a set of questions will be identified only by the unique identification number of patient 16, which is provided by staff 18 at the doctors office. Only the staff 18 at the doctor's office will be capable of matching patient identification number with actual patients. No demographic information, other than that used as criteria for question selections (such as age or gender) would be kept on file in the patient database 30 on server 10. As a result, the set of questions presented to patient 16 each time the patient visits the clinician's office is customized for that particular patient and is appropriate given the patient's current criteria.

An additional feature of the invention is the ability to perform practice based research. The invention supports a practice based research network (PBRN) that allows researchers to conduct research studies utilizing the systems installed screening base of existing clients. Researchers are able to create a small question set (5-10 questions) that is included along with the rest of the normal questions presented to the patients 16. PBRN questions sets are governed by their own rules. For example, series of questions in the PBRN question set may not be reported as a single question but, instead, may include the answers to all the questions in the series.

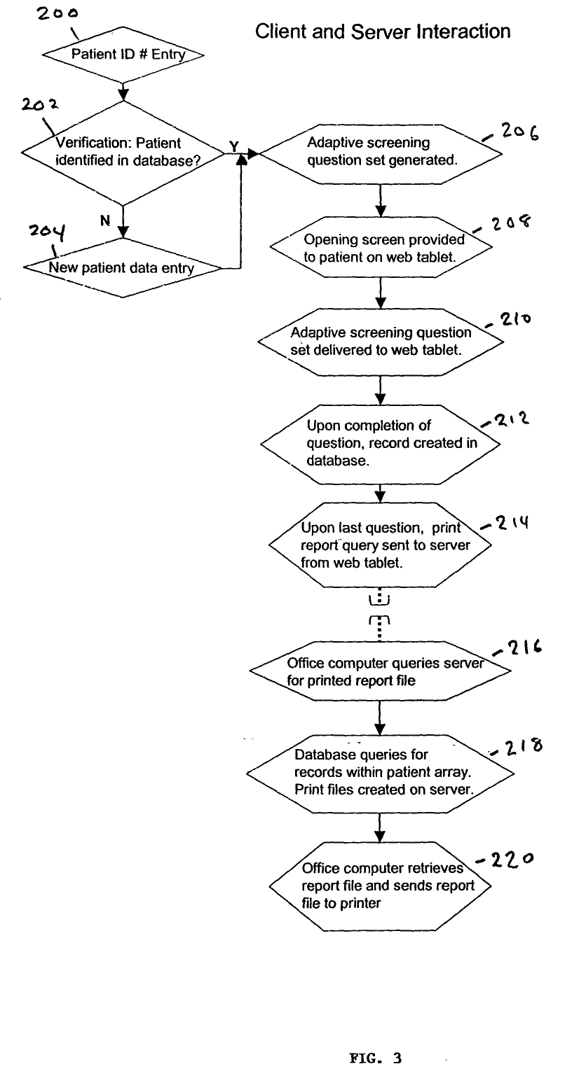

FIG. 3 shows the general flow of the interaction between client web tablets 12 and server 10. Server 10 consists of one or more centralized physical servers administering screening sessions to numerous remotely located computers within many doctor's offices. The centralized server 10 also delivers printed reports to printers within the doctor's offices. FIG. 3 shows the interaction between the client and the server. In box 200, a patient I.D. entry is made on the client's side in box 202, and a verification is made that the patient is in the database. If the patient is not recognized in the database, new patient data entry occurs in box 204. In box 206 the question set is generated for the particular patient. In box 208 the opening screen is provided to the patient on web tablet 12. In box 210, the set of screening questions is delivered to the web tablet 12. In box 212, upon completion of each question, the response is recorded in the database. In box 214, a request to print the reports is sent from the web tablet 12 to the server 10. In box 216, the computer 19 connected to printer 20 in the doctor's office queries the server for a file containing the printed report. In box 218, a query is made to the patient database for the particular patient I.D. and a print file is created on the server. In box 220, the office computer 19 retrieves the report file from server 10 and prints the report on printer 20.

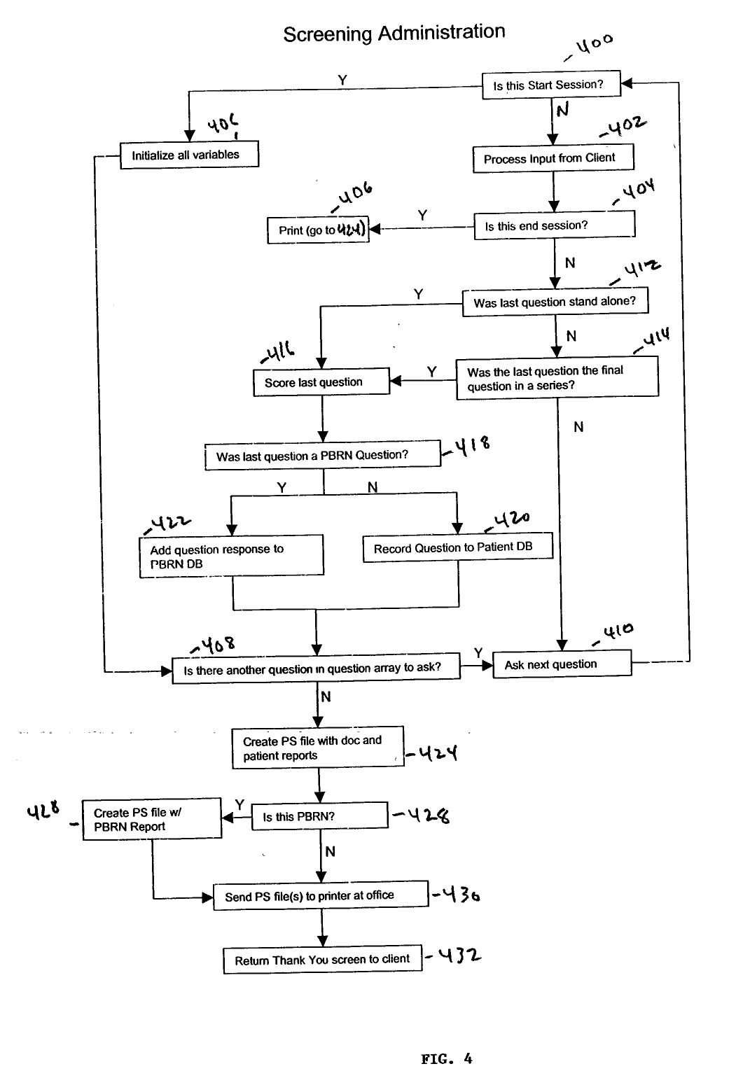

FIG. 4 shows a flow chart of the system's behavior during the administration of the screening for each individual patient. The session starts in box 400, and in box 406 all of the variables are initialized. In box 408, it is determined if there are questions to be asked and in box 410, the next question in the list gets asked. In box 402, the input from the client is processed and in box 404 a determination is made if the patient wants to end the session. If the patient does desire to end the session, box 406 sends the system to the printing routine, to print the patient report 24 and the doctors report 22. In box 412 it is determined if the last question ask was a stand alone question or a leader question for a series. If the question is a stand alone question, the question gets scored in box 416. If the question was not a stand alone question box 414 determines if the question was the final question in the series. If it was not the final question in the series, the next question in the series is asked in box 410. If the question was the-final question in the series, the series of questions is scored in box 416. Because series of questions are treated as a single question under the system, box 416 may provide a single score for the entire series of questions.

In box 418 the system determines if the last question asked was a PBRN study question. If so, box 422 adds the response to the question to a PBRN study database. If it was not a PBRN study question then the patient response gets recorded to the patient database 30. Box 408 then determines if there is another question to ask. If no more questions are left to be asked, the system, in box 424, creates a print file containing the doctor and patient reports 22 and 24 respectively. In box 428, if the report contained PBRN study questions, a PBRN report is printed out. In box 430, all of the reports are sent to the printer at the clinician's office and in box 432, the patient session is ended.

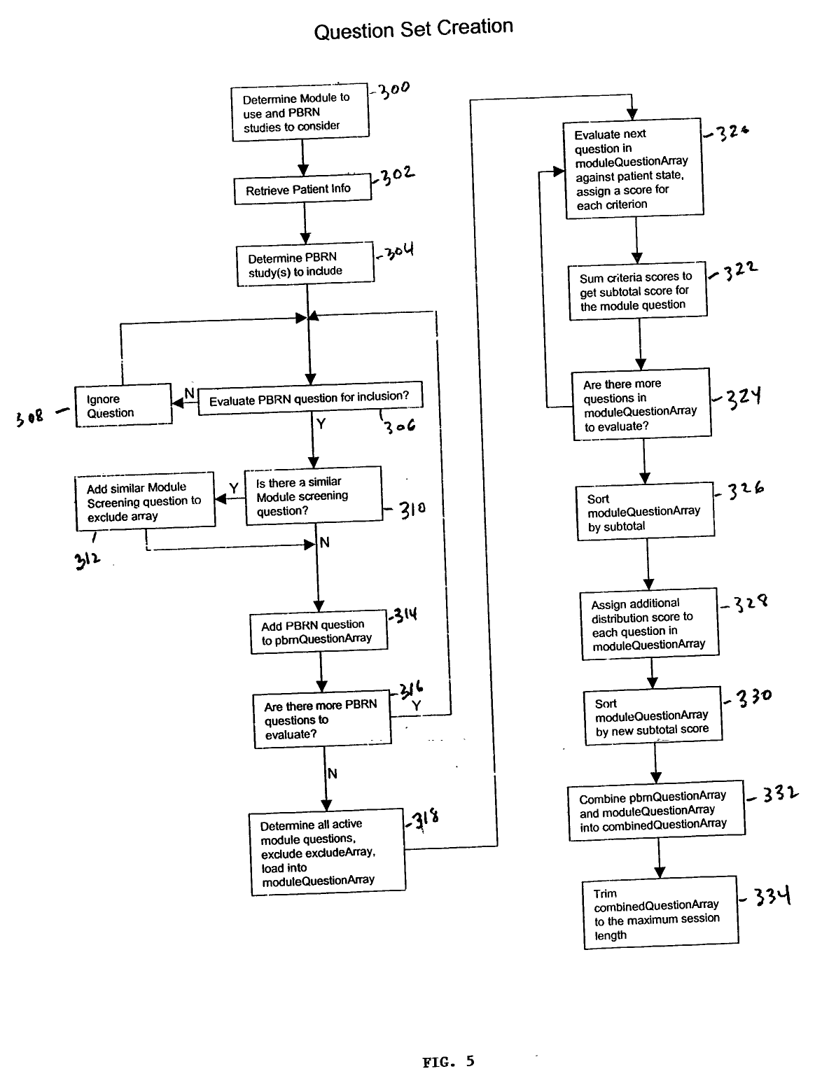

FIG. 5 is a flow chart showing the process by which a question set is created for each individual patient. In box 330, the system determines which module to use and which practice based research network (PBRN) studies to consider in the creation of the question set. It should be noted that server 11 can simultaneously be managing sessions from a plurality of different remote practices utilizing different modules containing different question matrices. Therefore, it must be determined, when a request comes in for a question set, which type of practice is generating the request. This could be accomplished by tying the practice identifier in with the individual patient identifier in the patient database. The determination of which module to use happens in box 300 of FIG. 5. In box 302, the patient information is retrieved from the patient database 32. In box 304, the system determines which practice-based research network studies, if any, to include in the question set. The determination of which PBRN studies to include may be predicated upon the state of the patient's information that is retrieved from patient database 30. Each of the questions in the PBRN study is evaluated for inclusion in the question set for the patient, in a manner identical to the evaluation done for all questions in the module question matrix. In box 306, if it is determined that the question is not suitable, the question is ignored in box 308 and the system moves on to the next question in the PBRN study. If it is determined that the question should be included in the system, box 310 determines if there is a similar question in the general question matrix for the module. If there is, that question is placed into an exclusion array in box 312. In box 314, the PBRN study question is added to the PBRN question array, and in 316 the system loops back to get the next question in the PBRN study. In box 318, the system determines all questions that are active in the current module's question matrix and excludes those that have been placed into the exclusion array. In box 326, each question in the question matrix (except for those in the exclusion array) is evaluated against the current state of the patient information, which includes all the variables collected for the patient, such as date of birth, gender, previous questions asked and responded to, etc. In boxes 332-334, all of the scores for each of the criteria are totaled for each question in the module's question matrix. In box 326, the questions are sorted according to their scores based on the evaluation of the criteria in box 320. In box 328, an additional distribution score is added to each question in the question matrix and the questions are again sorted. In box 332, the questions in the array of questions for the PBRN studies are combined with the questions from the normal module question matrix and the list is then trimmed to maximum number of questions allowed for each patient, which in the preferred embodiment is approximately 35. The questions are then served to the patient 16.

An additional feature of the invention is that a statistical report 23 may be printed out for the doctor regarding various trends in the responses to the questions, both from his patients and from all patients from all doctors' offices utilizing the system. For example, a doctor may want to know the top red flagged issue within his particular office or over the entire patient database 30 such that the doctor may pay particular attention to this issue with patients in the exam room during patient interaction times. Additionally the doctor can use this information to make any special arrangements that are necessary to address that particular issue such as buying equipment or ordering special medications, etc.

The present invention has been explained in the context of a pediatrician's office where the questions most likely are responded to by the parents of the children. However, as stated previously, this invention can be used in any setting where doctor-patient interaction takes place and with different question databases that are appropriate for each individual doctors setting. For example, a different question database would be used in a sports medicine clinic as opposed to a pediatrician's office. Therefore, the invention is not to be limited by the particular setting in which it is used but instead is defined by the scope of the claims which follow.

We claim:

1. A method of administering a computerized screening to a subject, comprising the steps of:
collecting information about said subject;
accessing a database of potential questions to ask said subject;
evaluating each of said questions in said database for relevancy with respect to said subject, based on said information collected about said subject;
selecting a subset of said questions in said database, based on said evaluations, to be presented to said subject; and
sequentially presenting said questions in said selected subset of questions to said subject.

2. The method of claim 1 wherein said screening is administered over a local area network or over the internet.

3. The method of claim 1 wherein said step of collecting information about said subject further comprises the steps of:
accessing a database of subject information to see if information regarding said subject is stored in said database;
if information regarding said subject is stored in said database, copying said information from said database;
if information regarding said subject is not stored in said database, collecting said information; and
storing said collected information in said database.

4. The method of claim 3 wherein information for each of said subjects is uniquely identified in said database.

5. The method of claim 1 wherein each of said questions is accompanied by a set of criteria and wherein said step of evaluating each of said questions in said database further comprises the steps of:
retrieving each of said questions and its related criteria from a database of questions;
matching said criteria for each of said questions against said information collected about said subject; and
scoring each of said questions based on said matching of said criteria against said subject information.

6. The method of claim 5 wherein one or more of said criteria for each question is scaled by a relevancy factor.

7. The method of claim 5 wherein said step of selecting a subset of said questions further comprises the steps of:
sorting said questions based on said scoring; and
selecting a predetermined number of questions based on said scores.

8. The method of claim 1 wherein some of said selected questions may be a series of questions and further wherein said step of sequentially presenting said questions in said selected subset of questions to said subject further comprises the steps of:
collecting a response from said subject to the current question;
determining if said current question is a leader question;
determining if said subject's response to said leader question indicates that a related series of questions should be asked; and
asking said related series of questions in lieu of said questions in said selected subset of questions from said database.

9. The method of claim 1 further comprising the steps of:
collecting the responses of said subject to each of said questions in said selected subset of questions;
evaluating said responses; and
red-flagging those questions for which said evaluation of said response meets certain criteria.

10. The method of claim 9 further comprising the step of storing said responses in said database of subject information.

11. The method of claim 9 further comprising the step of preparing one or more reports for said subject, said reports highlighting said red-flagged questions for follow-up.

12. The method of claim 11 wherein said one or more reports include information or pointers to information related to said red-flagged questions.

13. The method of claim 1 wherein said subject is presented said question and inputs said responses on a web-enabled appliance.

14. A system for administering a computerized screening to a subject, comprising:
a server for presenting questions to said subject and collecting responses to said questions from said subject;
a subject database for storing information about said subject;
a question database containing a plurality of questions and criteria related to each of said plurality of questions;
software for evaluating each of said questions in said question database for relevancy with respect to said subject, based on said information about said subject; and
software for presenting a subset of said plurality of questions to said subject, said subset of questions containing the most relevant questions for said subject.

15. The system of claim 14 wherein said server serves a web page, said web page being capable of presenting said subset of questions to said subject and collecting responses to said questions from said subject.

16. The system of claim 14 further comprising:
software for searching said subject database for information about said subject;
software for collecting information about said subject; and
software for storing said collected information in said database.

17. The system of claim 14 wherein said software for evaluating each of said questions in said question database performs said evaluation by matching relevant criteria associated with each question against said information about said subject, resulting in a score for each of said questions in said database.

18. The system of claim 17 wherein said score or each of said questions represents the relevancy of the questions with respect to said subject.

19. The system of claim 17 wherein said questions are sorted according to said score and further wherein said subset of questions presented to said subject are the most relevant questions.

20. The system of claim 19 wherein said subset of questions contains a predetermined number of the most relevant questions for said subject.

21. The system of claim 14 wherein one of said questions presented to said subject may be a series of related questions.

22. The system of claim 21 wherein said series of related questions starts with a leader question and further wherein subsequent questions in said series are asked only if a certain response is received from said subject to said leader question.

23. The system of claim 14 further comprising:
software for collecting said subject's responses to said questions and for evaluating said responses to said questions.

24. The system of claim 23 wherein certain of said questions may be red-flagged based on said subject's response thereto.

25. The system of claim 24 further comprising software for generating one or more reports for said subject, said reports highlighting said red-flagged questions.

26. The system of claim 26 wherein said one or more reports include information of pointers to information related to said red-flagged questions.

27. The system of claim 15 wherein said subject accesses said web page using a web-enabled appliance.

28. The system of claim 15 wherein said subject accesses said web page over a local area network or over the internet.

29. The system of claim 14 further comprising software for allowing the creation and editing of questions and question criteria in said question database.

30. The system of claim 29 wherein said software is a web-page which allows access to said question database.
